(19) United States
(12) Patent Application Publication
(10) Pub. No.: US 2006/0239410 A1
(43) Pub. Date: Oct. 26, 2006

(54) Method and apparatus for generating an x-ray image

(76) Inventor: Oliver Schutz, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 11/339,645

(22) Filed: Jan. 24, 2006

(30) Foreign Application Priority Data
Jan. 24, 2005 (DE) 10 2005 003 225.7

(51) Int. Cl. H05G 1/28

(52) U.S. Cl. 378/165

(57) ABSTRACT

In a method and an apparatus for generating an x-ray image of an examination subject, a measurement field is determined in the image field of the x-ray image, the measurement field being dependent on the position of a subject image region representing the examination subject in the image field and being essentially situated within this subject image region. The real value of a mean intensity of this measurement field is determined and compared with a stored desired value of the mean intensity to control the dose of the x-ray radiation.

### BACKGROUND OF THE INVENTION

1. Field of the Invention

The present invention concerns a method and an apparatus for generating an x-ray image of an examination subject.

2. Description of the Prior Art

In the implementation of diagnostic or therapeutic medical procedures, particularly for the image-support of an invasive procedure, it is often required to generate a number of x-ray images of the examination subject at short time intervals. For exposure or dose control, i.e. for control of the x-ray dose required for each x-ray image, it is known to calculate, for example, the arithmetic mean (average) of the intensity or the brightness in a measurement field (situated in the central image region) of an x-ray image. This mean is compared with a stored desired (reference) value. Using this comparison result, the dose for the acquisition of the next x-ray image is set so that the real value of the intensity or brightness substantially coincides with the desired value.

The measurement field used for the determination of the real value is static with regard to its position, shape and size, i.e. it is always the same in all exposures. In unfavorable cases, however, such a static measurement field can lead to a reduced image quality due to a non-optimal x-ray dose. One of the primary causes of this is direct radiation arriving in the measurement field, i.e. x-rays that have not penetrated the examination subject and thus are unattenuated. The real value of the intensity averaged over the measurement field is increased by this direct radiation. This leads to the x-ray dose being reduced in the following exposures until the desired value is reached. The result is an under-exposed x-ray image.

The cause for such a direct radiation in the measurement field can be, for example, a poor positioning of the examination subject during the imaging or the fact that the examination subject is smaller than the actual, statically-defined measurement field.

For a correct dose control, in particular in mobile C-arm x-ray apparatuses, it is therefore necessary for the user, the doctor or medical-technical auxiliary personnel to position the patient (i.e. the examination subject) such that virtually no direct radiation can strike the central measurement field. In other words, the central measurement field must optimally completely covered by the patient. In practice, however, such an ideal positioning of the patient is not always ensured or possible. In order to nevertheless acquire qualitatively good x-ray images in such cases, in principle the possibility exists to deactivate the automatic dose control and to manually control the acquisition parameters, but, this is not a satisfactory practical solution.

### SUMMARY OF THE INVENTION

An object of the present invention is to provide a method for generating an x-ray image of an examination subject that allows the image quality that can be achieved with automatic control of the x-ray dose to be improved under disadvantageous acquisition conditions. A further object of the invention is to provide an apparatus for implementation of such a method.

The above object is achieved according to the invention by a method for generating an x-ray image of an examination subject wherein a measurement field is determined in the image field of the x-ray image, this measurement field being dependent on the position of a subject image region that is representative of the position of the examination subject in the image field and that essentially lies within this subject image region. To control the dose of the x-ray radiation, the real value of a mean (average) intensity of this measurement field is determined and compared with a stored desired value of the mean intensity.

Since a measurement field dependent on the position of the examination subject in the image field (i.e. a dynamic measurement field) is used that essentially lies within this subject image region and thus at most contains a small fraction of direct radiation, it is ensured that the diagnostically-relevant regions of the x-ray image (i.e. the regions that actually coincide with the examination subject) are correctly exposed and are accordingly rendered in high contrast by means of the automatic dose control.

As used herein, “intensity” means the intensity, attenuation or brightness value of an image point. This value is preferably a value at the output of an x-ray receiver and normally already pre-processed by dark current correction. Alternatively, this value can be a grey value that is developed from this value via transformation with what is known as a lookup table in order to map the measured intensity values (that normally exist with a high resolution, for example 4096 grey levels) to the grey value region of the rendering medium, normally a monitor with 256 grey levels.

As used herein, “mean intensity” means an intensity value that is formed from the intensities of the individual image points (pixels) according to predetermined rules. For example, it can be an arithmetic mean, a median value or a mean weighted with predetermined weighting factors.

A particularly advantageous dose control is achieved when the measurement field completely lies within the subject image region, i.e. when each point of the measurement field is also an image point of the examination subject.

In a preferred embodiment of the method, the measurement field is determined by a comparison of the intensity distribution of a calibration image generated in the absence of the examination subject with predetermined acquisition parameters (in particular with a predetermined x-ray dose) with the intensity distribution of a first x-ray image generated in the presence of the examination subject with these acquisition parameters. This embodiment enables a reliable division of the subject image region representing the examination subject in the x-ray image from the direct radiation region.

A particularly reliable identification of the direct radiation or subject image region is possible when the intensity distribution of a direct radiation image is acquired in the absence of the examination subject and the intensity distribution of the calibration image is determined therefrom by multiplication of the intensity distribution of the direct radiation image with a scaling factor that is smaller than one.

In an embodiment of the method, the first x-ray image is compared point-by-point with the calibration image and the measurement field is formed by those image points whose intensity or brightness in the first x-ray image is smaller than in the calibration image. With embodiment, a measurement field is generated having a position and shape that substantially coincide with the position and shape of the subject image region representing the examination subject in the x-ray image.

As an alternative, a number of partial fields each containing a number of image points is established in the image field. The measurement field is then formed by those partial fields in which the intensity of each image point in the first x-ray image is smaller than a threshold of the intensity that is respectively associated with these partial fields in the calibration image. Computing capacity and storage space are reduced by this measure.

Instead of such a point-by-point comparison implemented within the partial fields, the measurement field can be formed from those partial fields having a mean intensity that is smaller in the first x-ray image than a threshold of the intensity that is respectively associated with these partial fields in the calibration image.

In practice, in particular with regard to computing capacity, it can be appropriate to use partial fields that cover only a part of the image field.

The above object also is achieved by an apparatus according the invention that implements the embodiments of the method summarized above.

### DESCRIPTION OF THE DRAWINGS

FIG. 1 shows a direct radiation image generated in the absence of an examination subject.

FIG. 2 shows a first x-ray image generated in the presence of an examination subject.

FIG. 3 shows a measurement field determined according to the invention.

FIG. 4 shows a direct radiation image generated in the absence of an examination subject and sub-divided into partial fields.

FIG. 5 shows a first x-ray image generated in the presence of the examination subject and likewise divided into partial fields.

FIG. 6 shows a measurement field assembled according to the invention from a number of partial fields.

FIG. 7 shows an alternative distribution of the partial fields in the image field.

FIG. 8 is a block of diagram of apparatus according to the invention.

### DESCRIPTION OF THE PREFERRED EMBODIMENTS

According to FIG. 1, an empty blank or direct radiation image 2 is generated in a first step with a predetermined set of acquisition parameters and in the absence of an examination subject. This direct radiation image 2 is composed of an approximately circular, brightly illuminated exposed image field 4 that is surrounded by a boundary region 6 generated with a diaphragm (for example a static aperture plate), an X-iris diaphragm or a filter diaphragm or with a mask used in digital image processing. This boundary region 6 is indicated in FIG. 1 with hatching and is not indicated in the following steps for determination of the measurement field. Moreover, for clarity the direct radiation image 2 is shown homogeneously white in FIG. 1. In practice, however, the intensity of the direct radiation in the image field 4 is not constant and moreover varies from apparatus to apparatus. The cause for this can be, for example, vignetting by the image intensifier, inhomogeneity of the beam filter, inhomogeneity of the x-ray radiation emitted by the x-ray source (Heel effect), or external interference sources.

The direct radiation image 2 can be processed by suitable digital image processing methods to reduce the image noise and to improve the image quality.

Since, in practice, given predetermined acquisition parameters the actual x-ray dose also can vary by several percent from exposure to exposure and the intensity distribution in the direct radiation image 2 can be influenced by further effects, the generated direct radiation images 2 are subjected to an additional post-processing in which the brightnesses or intensities of all image points are multiplied with a scaling factor (for example between 0.6 and 0.9). Such an effect is caused, for example, by variation of the spatial orientation of an image intensifier detector used as an x-ray receiver in an x-ray C-arm (change of the position of the C-arm). Such a variation of the orientation of the image intensifier detector leads to an easy image rotation and image displacement, since the image intensifier detector is influenced by the Earth's magnetic field. The scaling factor is empirically determined for each system type or, each model or series. A calibration image is then obtained as a result from each direct radiation image 2.

Such a calibration image is advantageously generated and stored for all acquisition parameter sets, for example for every possible dose adjustment. In some circumstances, however, it may not be necessary to generate and store a calibration image for every possible dose setting, but rather merely to generate and store only a calibration image at well-defined, larger dose intervals. The generation of the calibration images is preferably implemented at the manufacturer before the delivery of the x-ray system, and the calibration images as well as the associated acquisition data are permanently stored in the x-ray system. Due to unavoidable aging effects, however, it can be appropriate to update the calibration from time to time, for example after one or two years.

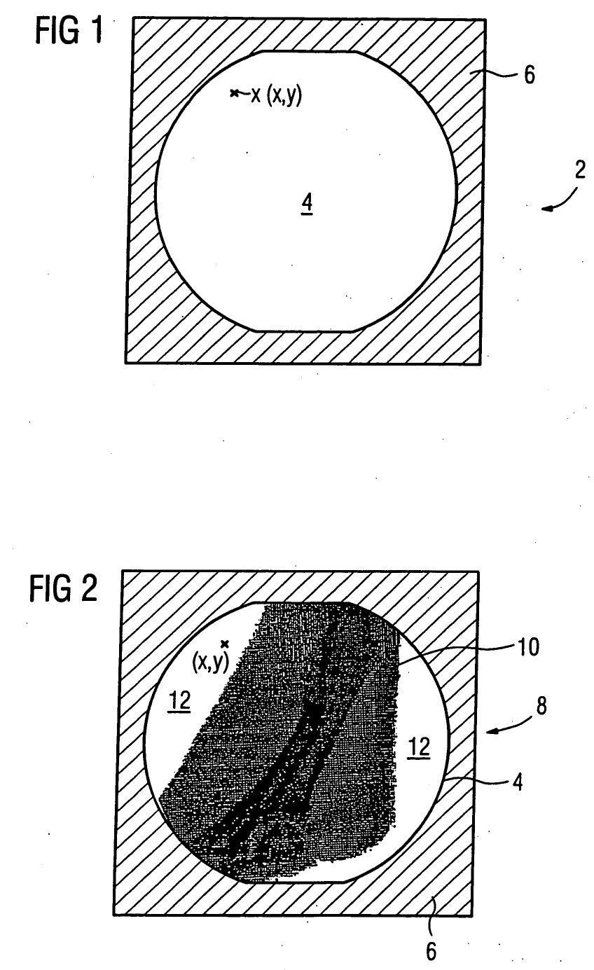

As shown in FIG. 2, a first x-ray image 8 is now generated in the presence of an examination subject in a second step. In the FIG. 2 it can be seen that this examination subject only occupies a subject image region 10 of a usable image field 4 situated within the screened boundary region 6, which subject image region 10 is smaller than the image field 4. Due to the smaller measurements of the examination subject, direct radiation regions 12 that brighten the image field 4 are located in the image field 4 in addition to this object image region 10. Given a dose control in which the measurement field significantly protrudes over the subject image region 10, these direct radiation regions 12 would lead to an underexposure of the subject image region 10. Moreover, a static measurement field that is significantly smaller than the subject image region 10 and, for example, lies in the center of the image field 4, also not lead to a correct dose control since, in this case, a soft tissue surrounding the bone in the shown example would be overexposed.

The image field 4 of the first x-ray image 8 is now compared image point-by-image point with the calibration image belonging to this acquisition parameter set. Each image point (x, y) of the first x-ray image 8 whose intensity I_{R}(X, y) is smaller than the intensity I_{K}(X, y) in the corresponding calibration image belongs to the subject image region 10. Each image point (x, y) in the first x-ray image 8 whose intensity I_{R}(X, y) is greater than or equal to the intensity I_{K}(X, y) in the corresponding calibration image is, with high probability, direct radiation and does not belong to the subject image region 10.

From such a point-by-point comparison of the intensities, a subject mask M(x, y) is formed that practically contains only the subject image region 10. This subject mask M(x, y) is formed according to the following rule:

If (I_{R}(x, y)<I_{K}(x, y) then M(x, y)=1

otherwise M(x, y)=0.

All image points of the subject mask M that belong to the subject image region 10 and thus to the examination subject are thus occupied with the value “1”; the other regions receive the value “0”. The measurement field for the dose control is now formed by those image points x, y for which: M(x, y)=1.

In order to enable a good separation between subject image region 10 and direct radiation region 12 with the method explained in the preceding, it is appropriate to use the first x-ray image in its raw form, thus before the execution of digital image processing or image improvement methods.

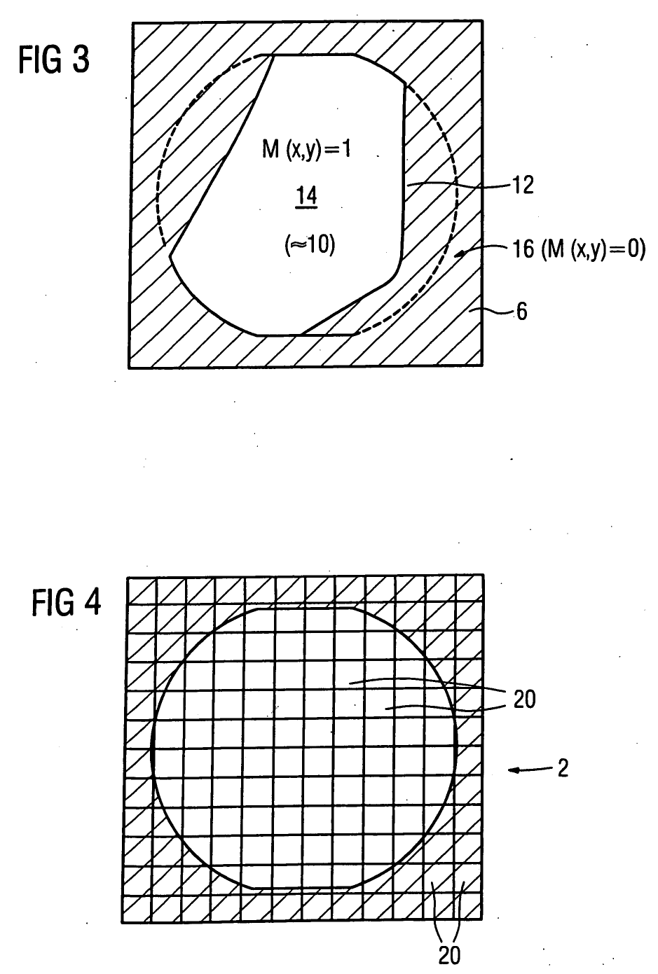

A measurement field 14 generated by point-by-point comparison is shown in FIG. 3 and approximately corresponds in terms of its shape and area to the shape and area of the subject image region 10. The remainder region 16 formed from direct radiation region 12 and boundary region 6 (indicated by hatching) is not used as a measurement field 14. This is formed by image points (x, y) for which: M(x, y)=0.

For the measurement field 14 determined in this manner, the real value of the mean intensity (for example the arithmetic mean of the intensity of the first x-ray image 8) is now determined and compared with a stored desired value of the mean intensity. The x-ray dose for the next x-ray image is controlled dependent on this comparison. From time to time, for example given a spatial variation of the examination subject, it can be necessary to effect a new determination of the measurement field. In principle, however, it is appropriate to re-determine the measurement field given each x-ray acquisition and to use the re-determined measurement field for the dose control in the next x-ray acquisition.

In the direct radiation image 2 shown in the exemplary embodiment according to FIG. 4, the entire image field 4 is separated into a plurality of quadratic partial fields 20. A threshold I_{S} of the intensity is now determined for each of these partial fields 20. For example, an arithmetic mean or a median value of the intensities of all image points in the partial field 20 is formed and multiplied with a scaling factor to form this threshold I_{S}. As an alternative, the threshold I_{S} is determined in that the minimal intensity value is determined and multiplied with a scaling factor within each partial field 20. In other words: a calibration image is generated in which only one threshold I_{S} is associated with each partial field 20.

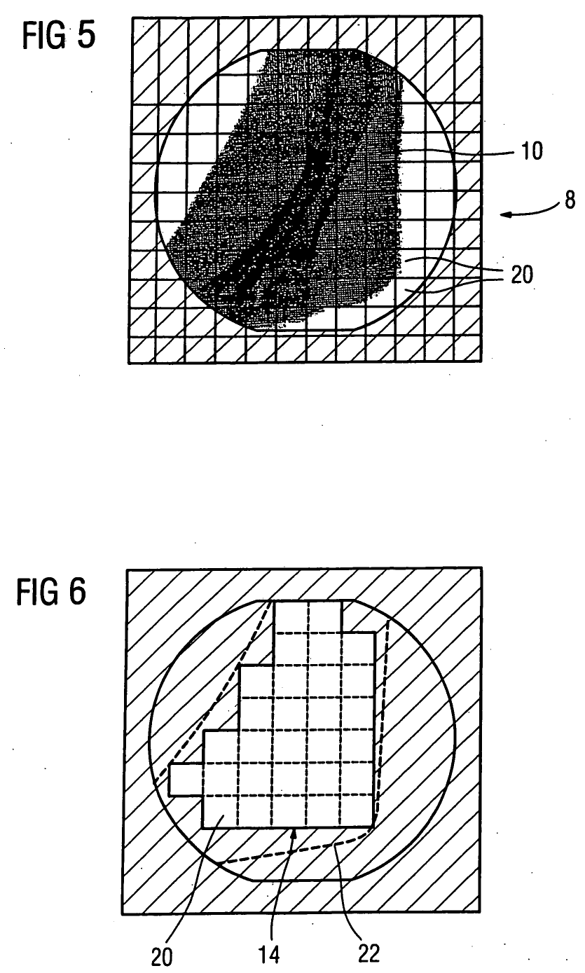

According to FIG. 5, a first x-ray image is now likewise generated in the presence of the examination subject in a subsequent step and the acquired image is likewise sub-divided into the same partial fields 20.

The formation of the measurement field 14 ensues analogously to the procedure illustrated in the preceding, whereby in the shown exemplary embodiment only those partial fields 20 in which each image point (x, y) within the partial field 20 exhibits an intensity I_{R}(x, y) that is smaller than the threshold I_{S} of the intensity of this partial field 20 in the calibration image are considered as belonging to the measurement field 14. Partial fields 20 that overlap with the subject image region 10 only in one partial region are thus not associated with the measurement field 14. The measurement field 14 shown in FIG. 6 is created in this manner. The measurement field 14 lies exclusively within the subject image region 10 reproducing the examination subject. The contour 22 of the subject image region 10 is indicated dashed in the FIG. 6. In other words: the measurement field 14 lies completely within the subject image region 10. The subject image region 10 and the measurement field 14 then do not entirely coincide, corresponding to the rough raster of the partial fields 20.

As an alternative to this procedure, a mean intensity can also be determined for each partial field 20 in the first x-ray image and compared with the respective thresholds I_{S} belonging to these partial fields 20. Only those partial fields whose mean intensity is smaller than the mean intensity of the corresponding partial field of the calibration image are then used for the measurement field. In this manner a measurement field would be created that is negligibly larger than the subject image region and also would contain partial fields at the edge of the subject image region that do not entirely lie within the subject image region.

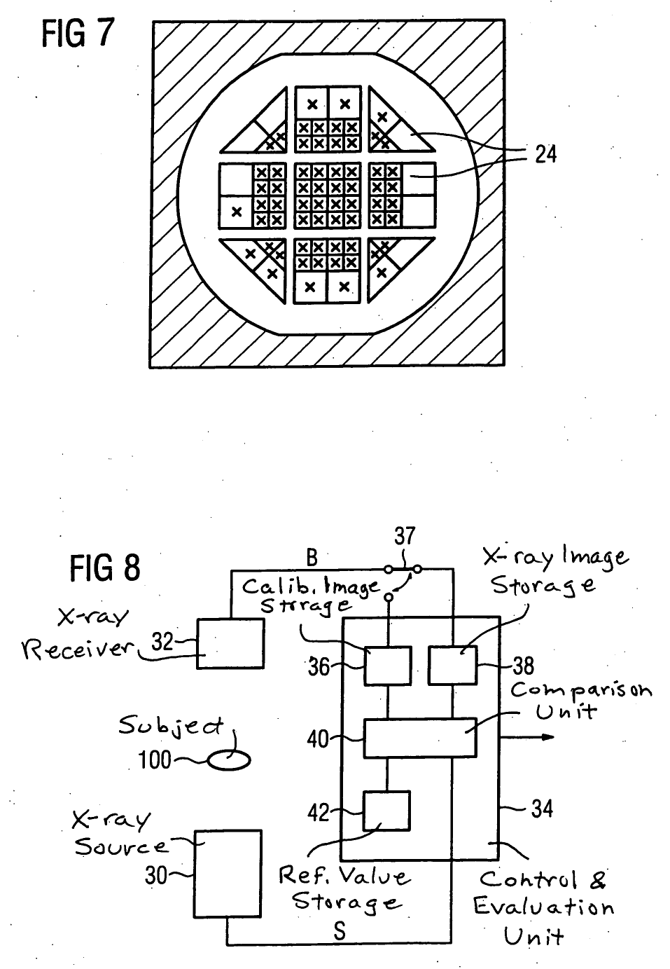

As an alternative to the methods respectively shown in FIGS. 1 through 3 and 4 through 6, in which the entire image field is selected for determination of the measurement field 14, in the exemplary embodiment explained in FIG. 7, partial fields 24 of different sizes and different shapes are used that cover only a part of the usable image field. In this exemplary embodiment, the selection of the partial fields 24 forming the measurement field also ensues with the algorithms described using FIGS. 4 though 6. In this exemplary embodiment, the measurement field 14 is then formed by the partial fields 24 (provided with a cross) when, as in the first variants explained using FIGS. 4-6, only those partial fields 24 that contain no image point whose intensity in the calibration image is larger than the intensity of the associated image point of the first x-ray image are considered.

According to FIG. 8, an apparatus for generation of an x-ray image of an examination subject 100 comprises an x-ray source 30 and an x-ray receiver 32. The image data B acquired (and, if applicable, post-processed) by the x-ray receiver 32 are supplied to a control and evaluation device 34 that generates a control signal S for dose control of the x-ray source 30. The control and evaluation device 34 comprises a calibration image storage 36 in which are stored a plurality of respective calibration images associated with an acquisition parameter set. These calibration images are generated from direct radiation images in a calibration mode according to the methods explained above, these direct radiation images having been determined for different acquisition parameter sets in the absence of the examination subject 100. The x-ray image of the examination subject 100 that was measured in a normal mode with a preset acquisition parameter set (symbolically represented by the closed selector switch) and stored in an x-ray image storage 38 is compared in a comparison device 40 with the stored calibration image belonging to this acquisition parameter set, and a measurement field is selected according to the algorithms explained in the preceding. For example, the arithmetic mean of the brightness or of the intensity of the first x-ray image is determined for this measurement field and compared with a desired value read out from a desired value storage 42. Dependent on this comparison result, this comparison device 40 generates the control signal S for control of the x-ray dose emitted by the x-ray source 30 for the next acquisition of an x-ray image of the examination subject 100.

I claim as my invention:

1. A method for preparing data for loading from a first data processing device into a second data processing device via a data connection, comprising the steps of:
updating an x-ray image of an examination subject having an image field containing a subject image region representing the examination subject;
in said image field of said x-ray image, automatically electronically determining a measurement field that is dependent on a position of the subject region in the image field, and that is substantially situated within said subject image region, and automatically electronically determining an average intensity of said measurement field and comparing said determined average intensity of said measurement field to a stored average intensity value, to obtain a comparison result; and
controlling a dose of x-ray radiation, dependent on said comparison result, to acquire a diagnostic x-ray image of the examination subject.

2. A method as claimed in claim 1, comprising determining said measurement field as being completely situated within said subject image region in said image field.

3. A method as claimed in claim 1, comprising the additional steps of:
generating a calibration image without said examination subject, using predetermined image acquisition parameters, said calibration image having an intensity distribution;
acquiring said x-ray image of said examination subject using said predetermined acquisition parameters, and automatically electronically determining an intensity distribution of said x-ray image of said examination subject;
automatically electronically determining said measurement field by comparing the intensity distribution of said calibration image with the intensity distribution of said x-ray image of the examination subject.

4. A method as claimed in claim 3, wherein the step of generating said calibration image comprises obtaining a direct radiation without said examination subject image and automatically electronically determining said intensity distribution of said calibration image by multiplying an intensity distribution of said direct radiation image with scaling factor that is less than 1.

5. A method as claimed in claim 3, comprising comparing said calibration image and said x-ray image of said examination subject pixel-by-pixel, and automatically electronically forming said measurement field from pixels in said x-ray image of the examination subject, having a characteristic selected from the group consisting of intensity and a brightness, that is less than said characteristic of a corresponding pixel in said calibration image.

6. A method as claimed in claim 3, comprising automatically electronically defining a plurality of partial fields, each containing a plurality of pixels, in each of said image fields and said x-ray image of said examination subject and said calibration image, and automatically electronically forming said measurement field from partial fields, among said plurality of partial fields in said x-ray image of the examination subject, wherein an intensity of each pixel is less than a threshold intensity of a corresponding partial field in said calibration image.

7. A method as claimed in claim 3, comprising automatically electronically defining a plurality of partial fields, each containing a plurality of pixels, in each of said image fields and said x-ray image of said examination subject and said calibration image, and automatically electronically forming said measurement field from partial fields, among said plurality of partial fields in said x-ray image of the examination subject, having an average intensity that is less than a threshold intensity of a corresponding partial field in said calibration image.

8. An apparatus for generating a diagnostic x-ray image of an examination subject, comprising:
an x-ray source adapted to emit x-rays that penetrate an examination subject;
an x-ray receiver on which x-rays from said x-ray source are incident, said x-rays incident on said x-ray receiver comprising x-rays that have penetrated the examination subject and x-rays that have not penetrated the examination subject, said x-ray receiver emitting electrical signals corresponding to the x-rays incident thereon;
a control and evaluation unit supplied with said electrical signals from said x-ray receiver, said control and evaluation unit forming an x-ray unit of the examination subject from the electronic signals, having an image field containing a subject image region representing the examination subject, said control and evaluation unit determining a measurement field dependent on a position of said subject image region in said image field and that is substantially situated within said subject image region, and determining an average intensity of said measurement field and comparing said average intensity with a stored average intensity to obtain a comparison result, and said control and evaluation unit controlling a dose of x-rays subsequently emitted by said x-ray source to obtain a diagnostic x-ray image of the examination subject.

9. An apparatus as claimed in claim 8 comprising a memory accessible by said control and evaluation unit, and wherein said control and evaluation unit operates said x-ray source to generate a calibration image without said examination of subject, said calibration image being stored in said memory and having an average intensity that is compared with the average intensity of said x-ray image of the examination subject by said control and evaluation unit to obtain said comparison result.
